(19) United States
(12) Patent Application Publication
(10) Pub. No.: US 2010/0089418 A1
(43) Pub. Date: Apr. 15, 2010

(54) PACKAGED PRIMER AND SCRUB PAD

(76) Inventors: Bernard Obereiner, Noblesville, IN (US); Joseph Kalwara, Indianapolis, IN (US)

Correspondence Address: BRIDGESTONE AMERICAS, INC., 1200 FIRESTONE PARKWAY, AKRON, OH, 44317, US

(21) Appl. No.: 12/526,897

(22) PCT Filed: Feb. 5, 2008
(86) PCT No.: PCT/US08/01495

§ 371 Date: Aug. 12, 2009

Related U.S. Application Data
(60) Provisional application No. 60/900,192, filed on Feb. 8, 2007.

(51) Int. Cl. B08B 7/00; B23P 17/04

(52) U.S. Cl. 134/6; 15/104.93; 29/428

(57) ABSTRACT

A pad assembly may include a scrub pad, a primer carried by the scrub pad, and a protective wrapper surrounding the pad. The protective wrapper includes a material that is substantially impervious to said primer.

This application claims the benefit of U.S. Provisional Patent Application Ser. No. 60/900,192 filed on Feb. 8, 2007, which is incorporated herein by reference.

### TECHNICAL FIELD

One or more embodiments of the present invention are directed toward a packaged pad carrying a primer.

### BACKGROUND

Installers of single ply roofing membranes use adhesive tape products for many purposes, such as seam splicing and for taped roof accessories around roof features. Primers are typically used to prepare roofing membranes and substrates to receive the tape adhesive products. These primers are conventionally applied by dipping a scrub pad into a container of primer material and using the scrub pad as an applicator. After a flash-off period, a sticky primed surface remains that enhances adhesion of the tape product. Further, the scrub pads dislodge and capture any dirt and debris that may be present on the surface receiving the primer and tape. Finally, the scrub pad functions to etch or scribe the membrane or substrate, which also promotes adhesion.

Currently, scrub pads are packaged dry, and the primer is transported to the roof separately in one, three, or five gallon containers. The scrub pads may be mounted on hand tools which may include elongated handles to allow a roof mechanic to stand during application. The scrub pad may then be dipped in primer so that the pad absorbs an amount of primer. The primer laden scrub pad is then pressed against a membrane or other substrate to apply the primer to areas that will receive tape adhesive products. The scrubbing action itself further prepares the membrane.

Providing primers and scrub pads in separate packaging increases the risk of roof mechanic error during application. For example, a scrub pad may be used with the incorrect primer, the roof mechanic may use the wrong primer for a given tape application, the roof mechanic may use an incorrect amount of primer, or the roof mechanic may use too much primer, which can result in prolonged flash-off periods and excessive fumes. Further, the mechanic may not have a scrub pad available, or may not have the right primer for the given membrane. Also, certain types of membranes and laps can be welded together, and consequently do not require primer for the majority of the installation. In these instances, the roof mechanic may not have primer and/or scrub pads readily available to install the smaller taped roof accessories.

Transporting primer in relatively large buckets or pails also presents unique problems. For example, typical primers are solvent based, and classified as “Flammable Liquid” when transported in one, three or five gallon containers. Shipping these volumes of flammable liquid requires the driver of the shipment to have a Haz-Mat endorsement license and also requires special labeling of the containers under Federal Regulations, which adds cost to transportation. Domestic ground shipments of smaller volumes of primers, however, do not require specially licensed drivers, and therefore may be undertaken at considerably less cost

In light of the above discussed problems, there exists a need in the art for a more convenient and safe method of packaging and transporting scrub pads and primers.

### SUMMARY OF THE INVENTION

One or more embodiments of the present invention provide a pad assembly comprising a scrub pad, a primer carried by the scrub pad, and a protective wrapper surrounding the pad and the protective wrapper including a material that is substantially impervious to the primer.

Other embodiments provide an accessory kit for use on a building roof including, a roof accessory, a pad assembly including a scrub pad, a primer carried by the scrub pad, and a protective wrapper surrounding the pad, the protective wrapper including a material that is substantially impervious to the primer, and a tape assembly including an adhesive tape and a release liner.

Other embodiments provide a method of preparing a roof surface for application of a tape adhesive including providing a pad assembly including a scrub pad carried within a protective wrapper, and a primer absorbed within the scrub pad, the protective wrapper including a wrapper material that prevents escape of the primer opening the wrapper and removing the scrub pad therefrom, and applying said scrub pad against the roof surface to remove contaminates and deposit the primer on the roof surface.

Other embodiments provide a method of installing a roof accessory on a roof surface including providing an accessory kit to the roof surface, the accessory kit including the roof accessory, a tape adhesive secured to the roof accessory and covered by a release liner, a pad assembly including a scrub pad, a primer carried by the scrub pad, and a protective wrapper surrounding the pad, opening the wrapper and removing the scrub pad therefrom, applying the scrub pad against the roof surface to form a primed and prepped area of the roof surface, removing the release liner from the tape adhesive, applying the tape adhesive to the primed area to thereby secure the roof accessory to the roof surface.

Other embodiments provide a kit for use on a roof including one or more pad assemblies, the pad assembly including a scrub pad, a primer carried by the scrub pad, and a protective wrapper surrounding the pad, the protective wrapper including a material that is substantially impervious to the primer; and at least one hand tool including a base plate and a handle, the base plate including cleats adapted to retain the scrub pad.

### BRIEF DESCRIPTION OF THE DRAWINGS

FIG. 1 is an elevated view of the packaged primer pad of the present invention;

FIG. 2 is an elevated view of the packaged primer pad showing the package partially open;

FIG. 3 is an exploded view of the hand tool and primer pad of the present invention;

FIG. 4 is an exploded view of an alternate hand tool for stand-up application and the primer pad of the present invention; and

FIG. 5 is an kit containing the packaged primer pad, roof accessory and instruction.

FIG. 6 is an elevated view of a roof surface showing a method of using the kit of FIG. 5.

FIG. 7 is an elevated view of a roof accessory being installed on a roof surface.

### DETAILED DESCRIPTION OF THE INVENTION

Single-ply roofing membranes are often formed of EPDM or TPO material. Sheets of TPO are typically extruded and sheets of composite EPDM are often formed (ie. by calendaring). In either case the membrane sheets typically include anti-stick agents on their surfaces to prevent contacting surfaces from sticking together. The membranes may then be wound into a roll for shipment. At the site of the roofing installation, the membrane is unrolled and joined together, for example, by lap seaming. Roof systems also require the installation of various roof accessories, such as drain inserts, pipe boots, pipe support systems, walkway pads, taped corners, taped T-joint patches, penetration pockets or the like. These accessories are typically secured to the membrane using an adhesive tape.

It is necessary that the anti-stick agents be removed from the portion of the membrane surface to which adhesion is desired prior to applying the adhesive tape for the lap seam or roof accessory. If the removal process is not thorough, the anti-stick agents will prevent the adhesive tape from thoroughly coating the surface area covered by the anti-stick agent. This may result in inferior adhesion, subsequent disbonding of the joint or accessory, and eventual penetration of water through the seam and/or accessory.

The anti-stick agents may be removed, or overcome simultaneously with the primer application, through employment of a primer having from about 3 to about 30 percent elastomeric solids content, used in conjunction with a mesh pad applicator. The application process entails removing a mesh pad saturated with primer stored within a protective wrapper and applying the saturated pad to the surfaces to receive tape. The contact of the mesh pad with the membrane surface scrubs and scours the surface during this process, and the anti-stick agent (or any other dirt or debris) is dislodged and caught-up and suspended in the primer-saturated pad, leaving the surface cleaned and coated with the primer.

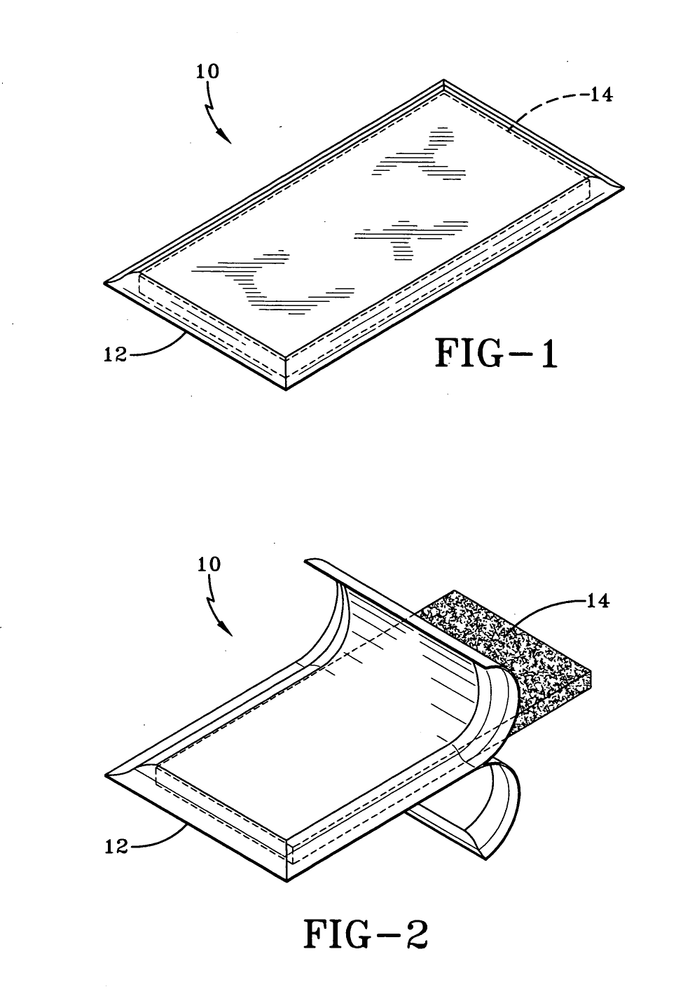

Referring now to FIG. 1, a pad assembly is shown, and indicated generally by the numeral 10. Pad assembly 10 includes a protective wrapper 12 that contains and surrounds a scrub pad 14. Scrub pad 14 is saturated with a predetermined amount of primer 15 and wrapper 12 prevents evaporation and/or leakage thereof.

Scrub pad 14 may take any shape. In one or more embodiments, scrub pad 14 may be rectangular. In other embodiments, scrub pad 14 may include a circular profile. The scrub pads contemplated by the invention may include a mesh, formed from woven or non-woven filamentary material, for example, cellulosic or plastic materials. A suitable pad for purposes of the invention is, for instance, Scotch-Brite™ General Purpose Hand Pad No. 7447, marketed by 3M Company, although other products may also be used. Scotch-Brite™ pads are typically formed from non-woven synthetic fibers to which an abrasive mineral is bonded by means of a polymer adhesive to form a web that is tough, open, chemically resistant, conformable and long-lasting. When such pads are made from a plastic, e.g., nylon, they resist tearing, splintering and shredding. In one or more embodiments scrub pad 14 may have a thickness of at least 0.25 inches, in other embodiments a thickness of at least 0.35 inches, in still other embodiments a thickness of at least 0.50 inches, and in yet other embodiments a thickness of at least 0.60 inches. In these or other embodiments scrub pad 14 may have a thickness of less than 1.0 inches, in other embodiments less than 0.90 inches, in still other embodiments a thickness of less than 0.80 inches, and in yet other embodiments a thickness of less than 0.70 inches. In one or more embodiments scrub pad 14 may have a grit of between approximately 200 and 260, in other embodiments a grit of between approximately 210 and 250, in still other embodiments a grit of between approximately 215 and 245, and in yet other embodiments a grit of between approximately 220 and 240.

In one or more embodiments, the scrub pads of the present invention may carry or absorb an advantageous amount of solvent. For example, in one embodiment, a three inch by three inch scrub pad (trade name “QuickScrubber”™ Pad) absorbs from about 25 to about 45 grams of solvent. In other embodiments, a three inch by three inch scrub pad absorbs at least about 30 grams and in other embodiments at least about 35 grams of solvent. A scrub pad carrying about 35 grams of primer adequately prepares and primes about two square feet of roof surface. A primed area of two square feet is typically all that is required to install a taped roof accessory.

Primers contemplated by the present invention may be solvent based. In one or more embodiments, solids may be suspended or dissolved in the solvent. In one or more embodiments, the primer may include at least 1% by weight, in other embodiments at least 2% by weight, in other embodiments at least 3% by weight, and in other embodiments at least 5% by weight solids. In these or other embodiments, the primer may include less than 20% by weight, in other embodiments less than 15% by weight, in other embodiments less than 12% by weight, and in other embodiments less than 10% by weight solids.

In one or more embodiments, the solids portion of the primer may include one or more polymers, oligomers, and other macromolecules. In these or other embodiments, the solids may include elastomers (i.e. polymers capable of being vulcanized into a material exhibiting the properties of a rubber). In these or other embodiments, the solids may include tackifying resins and/or hydrocarbon resins. In one or more embodiments the primer may have a Brookfield viscosity between approximately 50 and 2200 cps with a number 2 spindle at 20 RPM and at 73 degrees Fahrenheit. In other embodiments the primer may have a Brookfield viscosity between approximately 75 and 1500 cps, in still other embodiments between approximately 100 and 1200 cps, and in yet other embodiments a viscosity between 150 and 800 cps.

Suitable solvents may include organic solvents. These solvents may be polar or nonpolar, and may include aliphatic, aromatic, and naphthenic solvents. For example, the solvents may include heptane, toluene, methyl alcohol, xylene, and mixtures of two or more thereof. In one or more embodiments, the solvents may include halogenated solvents. In other embodiments, they may include aliphatic and aromatic blend solvents. In one or more embodiments the primer may include at least 90 percent solvent by weight, in other embodiments at least 80 percent solvent by weight, and in other embodiments at least 70 percent solvent by weight solvent. Commercial examples of suitable primers may include Firestone QuickPrime™ Plus, Firestone QuickPrime™ Plus LVOC, ADCO HSSP-1, Ashland PLIOSEAL™ 9705. Suitable primers and scrub pads are further disclosed in U.S. Pat. No. 5,976,292; U.S. Pat. No. 5,985,981; and U.S. Pat. No. 5,520,761, which are hereby incorporated by reference.

In one or more embodiments, the primer contains solvents and other carrier components including those compounds that evaporate under standard roof-top conditions of temperature and pressure. The time that it takes a solvent to evaporate from a primer composition after application to a membrane may be defined as the “flash-off” period. After solvent flash off, the remaining solids portion of the primer may be in the form of a thin film. In one or more embodiments, the primed area may be tacky and substantially free from dirt, debris or other contaminates that may inhibit adhesion between adjoining membranes.

The protective wrapper 12 creates a moisture impermeable barrier around the primer saturated scrub pad 14. Wrapper 12 is preferably composed of a solvent resistant material. In one or more embodiments wrapper 12 may be a foil material. In other embodiments, wrapper 12 may include a high density polyethylene material.

In one or more embodiments, wrapper 12 may advantageously be static dissipative. This may be achieved by providing a static dissipative inner liner or by forming the whole wrapper of a static dissipative material. The static dissipative material generally comprises any polymer or blend of polymers having suitable diffusion or permeation resistance and chemical resistance to the components comprising the particular primer which is to be contained. It may also be imbued with static dissipative properties by distributing electrically conductive carbon black therein. Such polymeric compositions having carbon black therein are discussed in U.S. Pat. No. 5,514,299, which is incorporated herein by reference. Whether anti-static or not, the polymeric wrapper material desirably exhibits resistance (i.e., resistance to chemical reaction, solvent absorption and swelling, and diffusion or permeation resistance) needed to prevent escape of primer from the wrapper prior to use. Exemplary materials and methods of forming static dissipative containers are disclosed in U.S. Pat. No. 5,514,299, which is hereby incorporated by reference.

Wrapper 12 remains sealed until scrub pad 14 is needed, at which point, it may be cut, torn or otherwise opened to allow removal of scrub pad 14 (shown in FIG. 2). Scrub pad 14 may thereafter be applied directly to a roof surface by hand, although suitable protective gear such as solvent resistant gloves and masks should be used. Scrub pad 14 may also be used in conjunction with a variety of application tools, which will be hereinafter described.

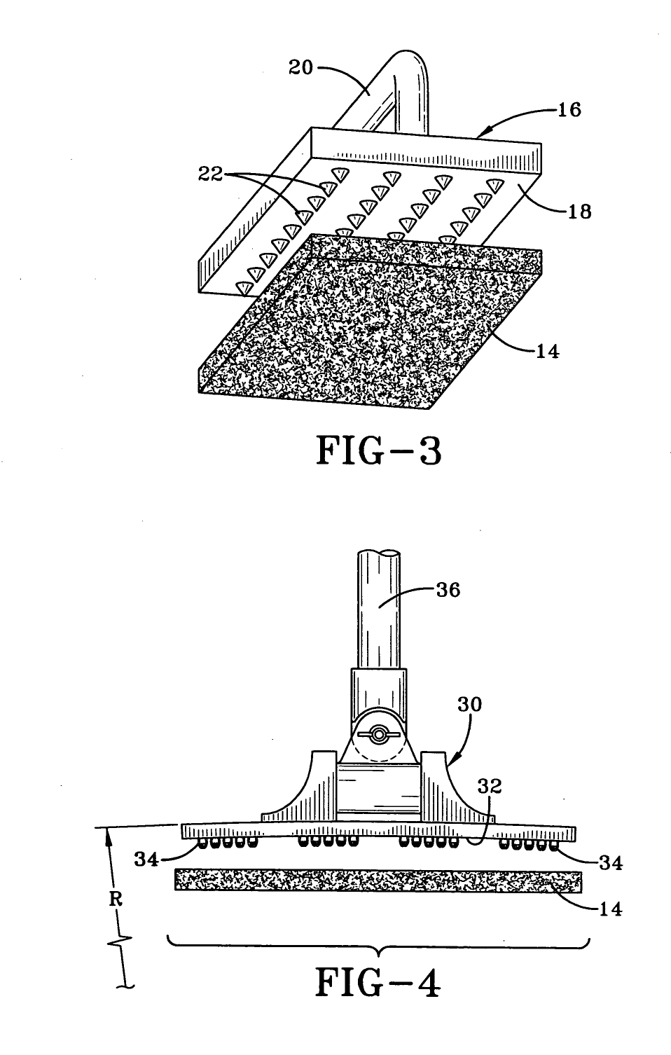

With reference now to FIG. 3, a hand applicator 16 includes a base plate 18 and a handle 20. Base plate 18 includes a plurality of retaining cleats 22 upon which scrub pad 14 may be impaled and retained. Applicator 16 is held and manipulated by grasping handle 20. When a scrub pad 14 is exhausted of its supply of primer, it is removed from cleats 22 and a new pad may be installed thereon.

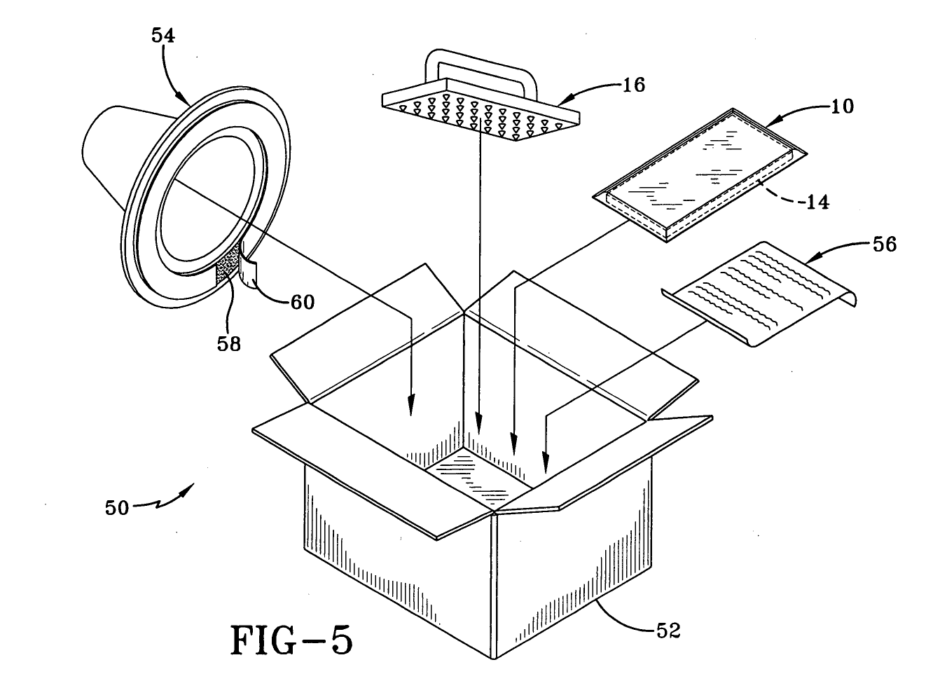

In accordance with another embodiment of the invention, an alternate scrub pad applicator is illustrated in FIG. 4. Specifically, an applicator 30 includes a bearing surface 32 including retaining cleats 34 which secure scrub pad 14 thereto. Bearing surface 32 may include a slight arch along the longitudinal direction which allows the bearing surface to be bent into the scrubbing area by the application of pressure through a handle 36, as handle 36 bears directly upon the high point of the arch. Handle 36 may pivot relative to bearing surface 32. Further, handle 36 may be about 4 to about 6 feet long, and made from a suitable material such as wood, plastic or metal.

A method of preparing lap seams using pad assembly 10 will now be described. In a first step, two membranes are placed in an adjacent, side-by-side relationship, the edges overlapping by the desired seam amount, for example, from about 3 to 5 inches. In a second step, a portion of the upper sheet is folded back over itself and temporarily held in that position, for instance, by the application of primer or other suitable material to form “tacking points” every 4 to 6 feet along the seam. In a third step, wrapper 12 is opened and scrub pad 14 is removed and optionally placed on a suitable applicator. In a fourth step, the primer contained within scrub pad 14 is applied to the lower surface of the folded-back membrane and to the upper surface of the other membrane, using long back-and-forth strokes with moderate to heavy pressure along the length of the splice area. A deposit of primer from about 3 to 9 wet mils thick, for example, will give satisfactory adhesion. When the supply of primer within the scrub pad 14 is exhausted, a new scrub pad is removed from its wrapper and placed on the applicator.

The primer is thereafter allowed to dry completely, usually requiring a period of less than about 10 minutes. In a fifth step, a strip of splice tape is applied to the primed upper surface of the membrane forming the lower portion of the seam. The splice tape, which is typically furnished in a roll as a laminate comprising the tape itself and a layer of release paper, is positioned with the release paper facing upwardly. Such tapes are taught, for example, in U.S. Pat. Nos. 6,120,869, 5,888,602, 5,859,114, 5,733,621, 5,612,141, 5,563,217, 5,545,685, 5,504,136, 5,242,727, 4,932,171, 4,849,268, 4,657,958, 4,855,172, 4,588,637, 4,539,344, and 4,426,468 which are incorporated herein by reference. In a sixth step, pressure is applied to the release paper surface, for example by a roller, firmly bonding the primed surface of the lower membrane to the exposed lower surface of the tape. In a seventh step, the release paper is removed from the tape and the top membrane is unfolded, allowing it to fall over the tape. In this manner, the primed surface of the upper membrane is brought into direct contact with the now exposed upper surface of the adhesive tape. In an eighth step, pressure is applied to the upper membrane along the entire seam area, conveniently with a hand-held roller, to achieve a finished seam.

Though pad assembly 10 may be used in the manner described above, it may also be advantageously used during installation of taped roof accessories. Roof accessories are used for a variety of reasons and may include, for example, drain inserts, pipe boots, pipe support systems, walkway pads, taped corners, taped T-joint patches, penetration pockets or the like. Further examples of taped roof accessories are described in U.S. Pat. No. 6,623,578 which is hereby incorporated by reference. Roofing accessories often include a factory applied tape with release liner. Further, installation of such items typically involves a relatively small adhesion area and thus a single scrub pad 14 may contain enough primer to prepare the entire adhesion area. Further, pad assembly 10 may be packaged with the roof accessory so that the resulting kit includes everything needed for installation.

Referring now to FIG. 5, a kit, generally indicated by the numeral 50, may include a container 52 or other appropriate packaging, primer pad assembly 10, a roof accessory 54 and instructions 56. Optionally, hand tool 16 or applicator 30 (not shown) may be provided therein. Further, protective equipment, such as solvent resistant gloves or masks may be provided within kit 50. In other embodiments, kit 50 may simply include one or more primer pad assemblies 10 and one or more hand tools 16 or applicators 30 within a container 52. Such a configuration may be advantageous if a roof mechanic already has one or more roof accessories.

In the present embodiment, roof accessory 54 is in the form of a pipe boot, but it should be appreciated that any roof accessory may be provided in kit 50. Pipe boots, as is known in the art, are positioned around pipes that extend through a roof membrane and prevent leaking at the interface thereof. Accessory 54 may include a factory applied tape 58 and protective release liner 60. Though the present embodiment shows a single roof accessory 54 and pad assembly 10, it should be appreciated that a plurality of each may be provided in each kit. In this manner, kit 50 includes all the materials necessary to install a taped roof accessory.

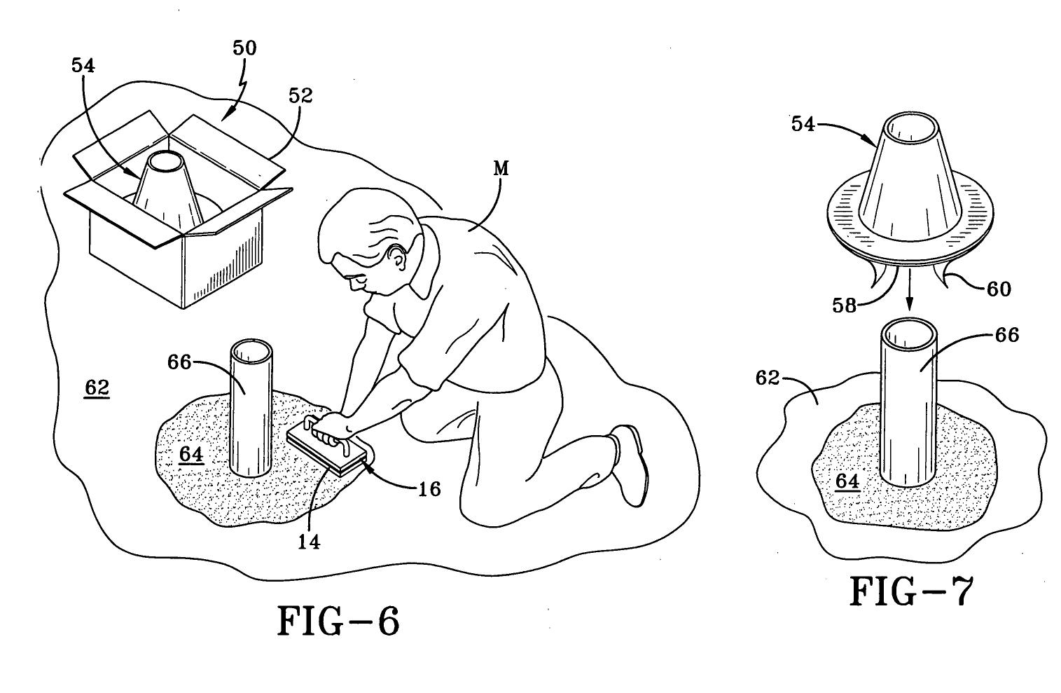

Referring now to FIG. 6, an exemplary method of using kit 50 will be described. In a first step, accessory kit 50 is provided to a roof mechanic on a flat or low slope roof. The roof includes a membrane 62 upon which the roof accessory 54 is to be installed. In a second step, pad assembly 10 is removed from kit 50 and wrapper 12 is removed from scrub pad 14. If a hand tool 16 or applicator 30 is provided in kit 50, then the second step may also include mounting scrub pad 14 on hand tool 16 or applicator 30. In a third step, pad 14 is applied to the surface of membrane 62 at the area that will receive tape 58. Using back-and-forth or circular strokes with moderate to heavy pressure the area is cleaned of any anti-stick material as well as any dirt or debris. Also, a deposit of primer is left on the membrane surface. Sufficient time is then allowed for the solvent portion of the primer to flash off. This results in a primed area 64 that is ready to receive tape 58.

Referring now to FIG. 7, in a fourth step, roof accessory 54 is positioned over primed area 64 and release liner 60 is removed. In a fifth step, the roof accessory is secured to membrane 62 by contacting adhesive tape 58 with primed area 64 and applying pressure thereto. Though the present embodiment includes a roof accessory having a factory applied tape 58, it should be appreciated that tape 58 could be provided separately. In this instance, pad 14 may be used to prime membrane 62 as well as the tape receiving surface of the accessory. Thereafter, tape may be applied to accessory 54 or membrane 62 and the accessory may thereafter be installed in the manner describe above.

Including the primer assembly 10 in the same kit with the accessory 54 ensures that the correct primer and pad is used with the correct tape and tape accessory. Further, the exact required amount of primer may be included in the scrub pad, eliminating waste. Still further, roof mechanic no longer needs to carry heavy containers of primer onto the roof to install the accessories. Additionally, by providing the primer in small quantities within the primer assembly, the domestic ground shipment of the primer assembly will not fall within the Federal Regulations requiring drivers to have Haz-Mat licenses and requiring special labeling, thereby reducing shipping costs. While in accordance with the patent statutes, a preferred embodiment and best mode has been presented herein, the scope of the invention is not limited thereto, but rather is measured by the scope of the attached claims.

1. A pad assembly comprising;
a scrub pad;
a primer carried by said scrub pad; and
a protective wrapper surrounding said pad, said protective wrapper including a material that is substantially impervious to said primer.

2. The pad assembly of claim 1, wherein said pad includes a meshed filamentary material.

3. The pad assembly of claim 1, wherein said pad includes a non-woven synthetic fiber material, said fiber material having an abrasive mineral bonded thereto.

4. The pad assembly of claim 1, wherein said primer includes solvents and polymeric materials.

5. The pad assembly of claim 4, wherein said primer is at least seventy percent solvent by weight.

6. The pad assembly of claim 4, wherein said primer solvent is volatile material at standard conditions.

7. The pad assembly of claim 4, wherein said primer solvents are selected from the group consisting of heptane, toluene, methyl alcohol, xylene, hydrocarbon and halogenated solvents, aliphatic or aromatic blend solvents.

8. The pad assembly of claim 1, wherein said wrapper includes a static dissipative material.

9. An accessory kit for use on a building roof comprising:
a roof accessory;
a pad assembly including a scrub pad, a primer carried by said scrub pad, and a protective wrapper surrounding said pad, said protective wrapper including a material that is substantially impervious to said primer; and
a tape assembly including an adhesive tape and a release liner.

10. The accessory kit of claim 9, further comprising a hand tool including a base plate and a handle, said base plate including cleats adapted to retain said scrub pad.

11. The accessory kit of claim 9, wherein said tape assembly is secured to said roof accessory.

12. The accessory kit of claim 9, wherein said pad includes a meshed filamentary material.

13. The accessory kit of claim 9, wherein said pad includes a non-woven synthetic fiber material, said fiber material having an abrasive mineral bonded thereto.

14. The accessory kit of claim 9, wherein said primer includes solvents and polymeric materials.

15. The accessory kit of claim 14, wherein said primer is at least seventy percent solvent by weight.

16. The accessory kit of claim 14, wherein said primer solvent is volatile material at standard conditions.

17. The accessory kit of claim 14, wherein said primer solvents are selected from the group consisting of heptane, toluene, methyl alcohol, xylene, hydrocarbon and halogenated solvents, aliphatic or aromatic blend solvents.

18. A method of preparing a roof surface for application of a tape adhesive comprising:
providing a pad assembly including a scrub pad carried within a protective wrapper, and a primer absorbed within said scrub pad, said protective wrapper including a wrapper material that prevents escape of said primer;
opening said wrapper and removing said scrub pad therefrom; and
applying said scrub pad against the roof surface to remove contaminates and deposit said primer on the roof surface.

19. A method of installing a roof accessory on a roof surface comprising;
providing an accessory kit to the roof surface, said accessory kit including the roof accessory, a tape adhesive secured to the roof accessory and covered by a release liner, a pad assembly including a scrub pad, a primer carried by said scrub pad, and a protective wrapper surrounding said pad;
opening said wrapper and removing said scrub pad therefrom;
applying said scrub pad against the roof surface to form a primed and prepped area of the roof surface;
removing said release liner from said tape adhesive;
applying said tape adhesive to said primed area to thereby secure the roof accessory to the roof surface.

20. A kit for use on a roof comprising:
one or more pad assemblies, said pad assembly including a scrub pad, a primer carried by said scrub pad, and a protective wrapper surrounding said pad, said protective wrapper including a material that is substantially impervious to said primer; and
at least one hand tool including a base plate and a handle, said base plate including cleats adapted to retain said scrub pad.
